(19) United States
(12) Patent Application Publication
(10) Pub. No.: US 2026/0175783 A1
(43) Pub. Date: Jun. 25, 2026

(54) CENTER CONSOLE

(71) Applicant: SUBARU CORPORATION, Tokyo (JP)

(72) Inventors: Hidenobu ABE, Tokyo (JP); Atsushi NAKAJIMA, Tokyo (JP)

(21) Appl. No.: 19/411,791

(22) Filed: Dec. 8, 2025

(30) Foreign Application Priority Data
Dec. 24, 2024 (JP) 2024-227518

(51) Int. Cl. B60R 7/04

(52) U.S. Cl. CPC B60R 7/04

(57) ABSTRACT

A center console includes: a console box disposed between a pair of seats arranged in a vehicle width direction; and a bracket configured to fix the console box to a floor of a vehicle. The bracket includes: a lower bracket; and an upper bracket disposed on the lower bracket. The upper bracket includes a pair of projections facing seat frames of the seats respectively in the vehicle width direction. Each of the projections includes: a first contour extending vertically when viewed in a front-rear direction of the vehicle; and a second contour extending downward and inward in the vehicle width direction from an upper end of the first contour when viewed in the front-rear direction. The lower bracket includes: an upper wall that supports a lower end of the second contour of each of the projections; and a support wall disposed between the upper wall and the floor.

### CROSS-REFERENCE TO RELATED APPLICATIONS

The present application claims priority from Japanese Patent Application No. 2024-227518 filed on December 24, 2024, the entire contents of which are hereby incorporated by reference.

### BACKGROUND

The disclosure relates to a center console.

A vehicle may include a center console between seats arranged in a vehicle width direction. For example, Japanese Patent No. 6599928 discloses a console assembly having a support structure that serves as a side impact reinforcement. The console assembly includes a console housing and the support structure. The console housing is secured to the support structure, and the support structure is secured to a floor. The support structure includes a pair of side walls and a platform wall extending between the pair of side walls. The platform wall is secured to inner surfaces of the pair of side walls. In the event of a side impact on a seat, a seat rod transmits a force to a side wall of the support structure, and the support structure serves as a side impact reinforcement.

### SUMMARY

An aspect of the disclosure provides a center console. The center console includes: a console box disposed between a pair of seats arranged in a vehicle width direction; and a bracket configured to fix the console box to a floor of a vehicle. The bracket includes: a lower bracket; and an upper bracket disposed on the lower bracket. The upper bracket includes a pair of projections facing seat frames of the seats respectively in the vehicle width direction. Each of the projections includes: a first contour extending vertically when viewed in a front-rear direction of the vehicle; and a second contour extending downward and inward in the vehicle width direction from an upper end of the first contour when viewed in the front-rear direction. The lower bracket includes: an upper wall configured to support a lower end of the second contour of each of the projections; and a support wall disposed between the upper wall and the floor.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic front view illustrating a center console according to an embodiment;

FIG. 2 is a schematic perspective view illustrating a bracket;

FIG. 3 is a schematic front view illustrating the bracket;

FIG. 4 is a schematic exploded front view illustrating the bracket;

FIG. 5 is a schematic side view illustrating the bracket; and

FIG. 6 is a schematic exploded side view illustrating the bracket.

### DETAILED DESCRIPTION

In Japanese Patent No. 6599928, when the height from the platform wall to a contact position between the seat rod and a side wall is large, a large moment acts on the side wall. In this case, the side wall may be bent inward and the support structure may be unable to work as intended.

It is desirable to provide a center console capable of improving strength against a side load.

Hereinbelow, a preferred embodiment of the disclosure will be described in detail with reference to the accompanying drawings. Specific dimensions, materials, numerical values, and the like provided in the embodiments are merely examples for facilitating understanding of the disclosure, and do not limit the disclosure unless otherwise specified. In this specification and the drawings, elements having substantially the same functions and configurations are denoted by the same reference numerals to omit redundant description, and elements not directly related to the disclosure are not illustrated.

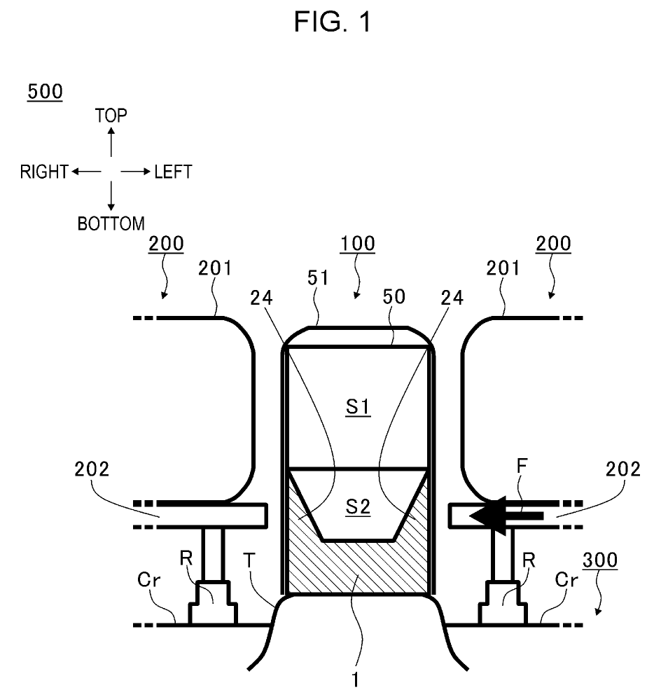

FIG. 1 is a schematic front view illustrating a center console 100 according to an embodiment. FIG. 1 illustrates only seat cushions 201 and components below the seat cushions 201 in seats 200, and other components, such as seat backs and headrests, are not illustrated. In FIG. 1, a bracket 1 is hatched for better understanding.

The center console 100 is disposed between the two seats 200 arranged in the vehicle width direction (left-right direction) of a vehicle 500. For example, in the present embodiment, the seats 200 may be a driver's seat and a passenger seat. In another embodiment, the seats 200 may be rear seats.

For example, each seat 200 includes the seat cushion 201, a seat frame 202, and seat rails R. The seat 200 may further include other components.

The seat cushion 201 includes a cushion material such as urethane foam, for example. The seat cushion 201 is attached to the seat frame 202.

The seat frame 202 forms the main structure of the seat 200. For example, in the seat frame 202, the portion that supports the seat cushion 201 may include a pair of side frames that extend in the front-rear direction of the vehicle 500 and a seat pan that couples the pair of side frames.

The seat frame 202 is slidably attached to the seat rails R. The seat rails R enable position adjustment of the seat 200 in the front-rear direction. The seat rails R are fixed to a floor 300. For example, the seat rails R may be fixed to a cross member cR of the floor 300.

The floor 300 includes a floor tunnel T. The floor tunnel T extends in the front-rear direction of the vehicle 500, between the two seats 200.

The center console 100 is fixed to the floor 300. In the present embodiment, the center console 100 is fixed to the floor tunnel T of the floor 300. For example, the center console 100 includes a console box 50, the bracket 1, and a cover 51. The center console 100 may further include other components.

The console box 50 serves as a storage. The console box 50 defines a space S1 for receiving objects.

The bracket 1 is used to fix the console box 50 to the floor tunnel T. The bracket 1 will be described in detail below.

A space S2 is defined between the bracket 1 and the console box 50. For example, the space S2 may house components such as ducts or wires.

The cover 51 covers the console box 50 and the bracket 1. The cover 51 can improve the appearance of the interior decoration.

Next, the bracket 1 will be described.

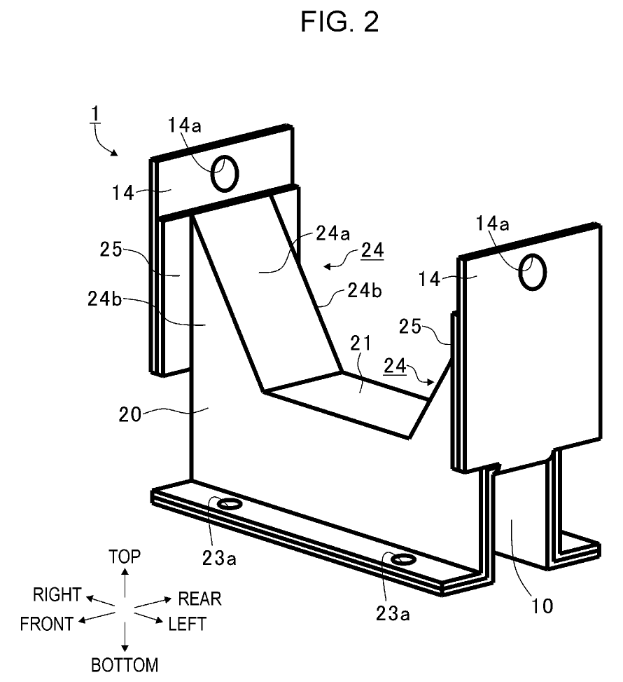

FIG. 2 is a schematic perspective view illustrating the bracket 1.

The bracket 1 includes a lower bracket 10 and an upper bracket 20. In the present embodiment, the lower bracket 10 is configured to be fixed to the floor 300, specifically, the floor tunnel T (in FIG. 2 and FIGS. 3 to 6 described below, the floor 300 and the floor tunnel T are not illustrated). The upper bracket 20 is configured to be stacked on the lower bracket 10.

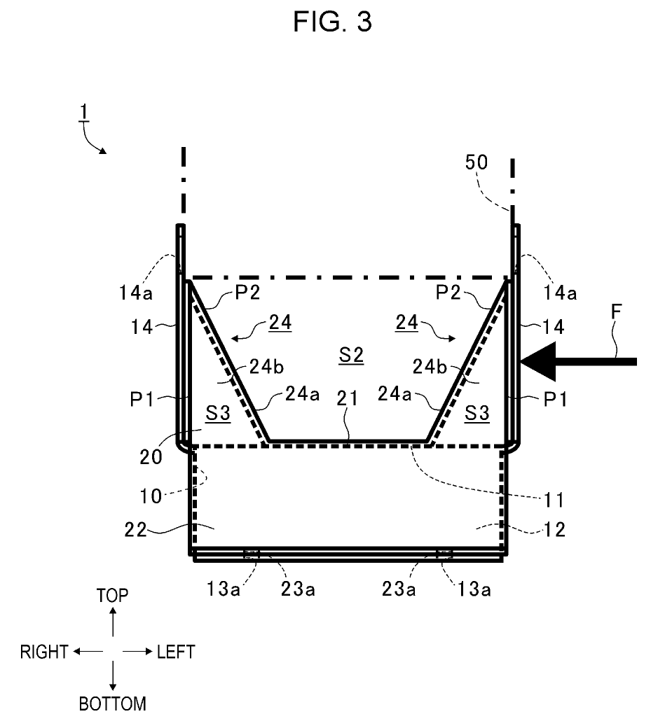

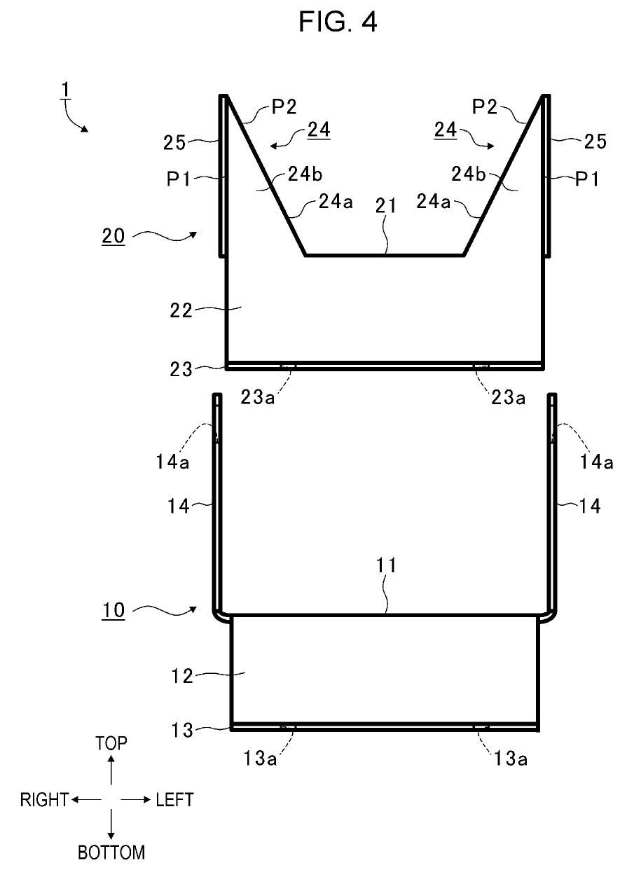

FIG. 3 is a schematic front view illustrating the bracket 1. FIG. 4 is a schematic exploded front view illustrating the bracket 1.

Referring to FIG. 4, the lower bracket 10 includes an upper wall 11 and a pair of support walls (first support wall, second support wall) 12. The lower bracket 10 may further include other components.

The upper wall 11 extends in the front-rear direction and the left-right direction of the vehicle 500. The upper wall 11 does not have to be completely parallel to the front-rear direction and the left-right direction, and the upper wall 11 may be inclined with respect to one or more of the front-rear direction and the left-right direction.

The support walls 12 extend in the top-bottom direction and the left-right direction of the vehicle 500. The support walls 12 do not have to be completely parallel to the top-bottom direction and the left-right direction, and the support walls 12 may be inclined with respect to one or more of the top-bottom direction and the left-right direction.

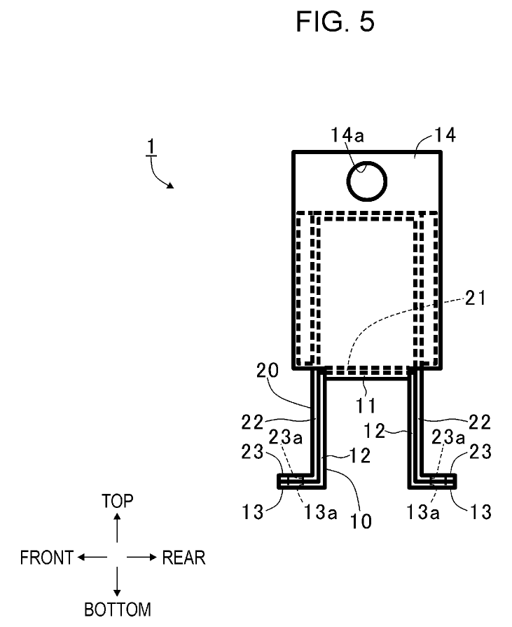

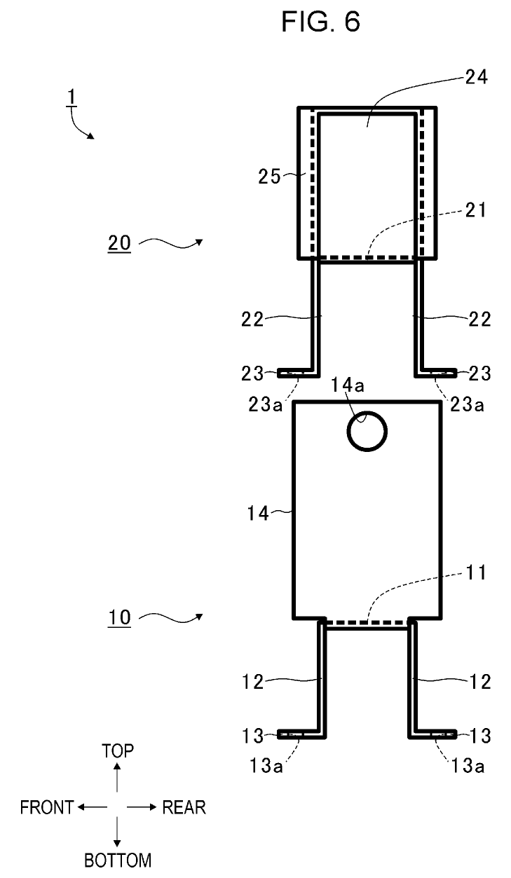

FIG. 5 is a schematic side view illustrating the bracket 1. FIG. 6 is a schematic exploded side view illustrating the bracket 1.

Referring to FIG. 6, the two support walls 12 are spaced apart from each other and opposed to each other in the front-rear direction of the vehicle 500. The upper wall 11 is coupled to upper ends of the pair of support walls 12. In the present embodiment, the two support walls 12 are symmetric with respect to a plane extending in the top-bottom direction and the left-right direction. In another embodiment, the two support walls 12 may be asymmetric with respect to a plane extending in the top-bottom direction and the left-right direction. In the present embodiment, the support walls 12 may also be referred to as side walls.

In the present embodiment, the upper wall 11 and the pair of support walls 12 form a substantially inverted U-shaped cross section when viewed in the left-right direction.

The lower bracket 10 further includes a fixing flange 13 for each of the pair of support walls 12. The fixing flanges 13 extend in the front-rear direction and the left-right direction of the vehicle 500. The fixing flanges 13 do not have to be completely parallel to the front-rear direction and the left-right direction, and the fixing flanges 13 may be inclined with respect to one or more of the front-rear direction and the left-right direction. The fixing flanges 13 are coupled to the lower ends of the support walls 12. The two fixing flanges 13 protrude away from each other in the front-rear direction, from the lower ends of the support walls 12. In the present embodiment, the two fixing flanges 13 are symmetric with respect to a plane extending in the top-bottom direction and the left-right direction. In another embodiment, the two fixing flanges 13 may be asymmetric with respect to a plane extending in the top-bottom direction and the left-right direction. In the present embodiment, each of the fixing flanges 13 has a through hole 13a.

The lower bracket 10 further includes a pair of side flanges 14. The side flanges 14 extend in the top-bottom direction and the front-rear direction of the vehicle 500. The side flanges 14 do not have to be completely parallel to the top-bottom direction and the front-rear direction, and the side flanges 14 may be inclined with respect to one or more of the top-bottom direction and the front-rear direction.

Referring to FIG. 4, one side flange 14 is coupled to the right end of the upper wall 11, and the other side flange 14 is coupled to the left end of the upper wall 11. The side flanges 14 project upward from the upper wall 11. The two side flanges 14 are spaced apart from each other and opposed to each other in the left-right direction. In the present embodiment, the two side flanges 14 are symmetric with respect to a plane extending in the top-bottom direction and the front-rear direction. In another embodiment, the two side flanges 14 may be asymmetric with respect to a plane extending in the top-bottom direction and the front-rear direction. In this embodiment, each side flange 14 has a through hole 14a. The side flanges 14 cover first contours P1 of projections 24, which will be described below, from the outer side in the vehicle width direction.

FIG. 3 illustrates the lower part of the console box 50 with a chain line. In this embodiment, the console box 50 is disposed between the pair of side flanges 14. In the present embodiment, the console box 50 is fixed to the pair of side flanges 14 with two bolts (not illustrated) passing through the through holes 14a in the side flanges 14.

The lower bracket 10 as described above may be formed by, for example, pressing a metal plate.

Referring to FIG. 4, the upper bracket 20 includes an upper wall 21 and a pair of side walls 22. The upper bracket 20 may further include other components.

The upper wall 21 extends in the front-rear direction and the left-right direction of the vehicle 500. The upper wall 21 does not have to be completely parallel to the front-rear direction and the left-right direction, and the upper wall 21 may be inclined with respect to one or more of the front-rear direction and the left-right direction.

The side walls 22 extend in the top-bottom direction and the left-right direction of the vehicle 500. The side walls 22 do not have to be completely parallel to the top-bottom direction and the left-right direction, and the side walls 22 may be inclined with respect to one or more of the top-bottom direction and the left-right direction.

Referring to FIG. 6, the two side walls 22 are spaced apart from each other and opposed to each other in the front-rear direction of the vehicle 500. The upper wall 21 is coupled to upper ends of the pair of side walls 22. In the present embodiment, the two side walls 22 are symmetric with respect to a plane extending in the top-bottom direction and the left-right direction. In another embodiment, the two side walls 22 may be asymmetric with respect to a plane extending in the top-bottom direction and the left-right direction.

In the present embodiment, the upper wall 21 and the pair of side walls 22 form a substantially inverted U-shaped cross section when viewed in the left-right direction.

The upper bracket 20 further includes a fixing flange 23 for each of the pair of side walls 22. The fixing flanges 23 extend in the front-rear direction and the left-right direction of the vehicle 500. The fixing flanges 23 do not have to be completely parallel to the front-rear direction and the left-right direction, and the fixing flanges 23 may be inclined with respect to one or more of the front-rear direction and the left-right direction. The fixing flanges 23 are coupled to lower ends of the side walls 22. The two fixing flanges 23 protrude away from each other in the front-rear direction, from the lower ends of the side walls 22. In the present embodiment, the two fixing flanges 23 are symmetric with respect to a plane extending in the top-bottom direction and the left-right direction. In another embodiment, the two fixing flanges 23 may be asymmetric with respect to a plane extending in the top-bottom direction and the left-right direction.

Referring to FIG. 5, the upper wall 21, the side walls 22, and the fixing flanges 23 of the upper bracket 20 are disposed on the outer surfaces of the upper wall 11, the support walls 12, and the fixing flanges 13 of the lower bracket 10, respectively. For this reason, the cross section of the upper bracket 20 is slightly larger than the cross section of the lower bracket 10. At least a part of the upper wall 21, the side walls 22, and the fixing flanges 23 of the upper bracket 20 is fixed to the upper wall 11, the support walls 12, and the fixing flanges 13 of the lower bracket 10, respectively, by a fixing method such as spot welding or an adhesive.

In this embodiment, each fixing flange 23 has a through hole 23a.

In the present embodiment, the lower bracket 10, the upper bracket 20, and the floor tunnel T are fastened together with bolts (not illustrated) passing through the through holes 13a in the lower bracket 10 and the through holes 23a in the upper bracket 20, so that the lower bracket 10 and the upper bracket 20 are fixed to the floor tunnel T.

Referring to FIG. 2, the upper bracket 20 further includes a pair of projections 24. The projections 24 protrude upward from the upper wall 21. The upper ends of the projections 24 are lower than the upper ends of the side flanges 14 of the lower bracket 10. Hence, the through holes 14a in the side flanges 14 are not covered by the projections 24.

Referring to FIG. 4, when viewed in the front-rear direction of the vehicle 500, each projection 24 includes the first contour P1 extending vertically and the second contour P2 extending downward and inward in the vehicle width direction of the vehicle 500 from the upper end of the first contour P1. From another standpoint, in the present embodiment, each projection 24 has a substantially right-triangular contour when viewed in the front-rear direction of the vehicle 500.

In the present embodiment, the first contours P1 extend perpendicularly to the upper wall 21. In another embodiment, the first contours P1 do not have to be perpendicular to the upper wall 21. In the present embodiment, the second contours P2 extend downward and inward in the vehicle width direction of the vehicle 500 from the upper ends of the first contours P1. The lower ends of the second contours P2 are located above the upper wall 11 of the lower bracket 10.

Referring to FIG. 2, more specifically, in the present embodiment, each projection 24 includes an inclined wall 24a and a pair of side walls 24b. The side walls 24b have a substantially right triangular shape when viewed in the front-rear direction of the vehicle 500. The inclined wall 24a is coupled to the hypotenuses of the two side walls 24b.

Referring to FIG. 4, each of the first contours P1 is defined by a leg of the corresponding side wall 24b when viewed in the front-rear direction of the vehicle 500. Each of the second contours P2 is defined by the hypotenuse of the corresponding side wall 24b, or the inclined wall 24a, when viewed in the front-rear direction of the vehicle 500.

Referring to FIG. 3, the inclined walls 24a of the projections 24 and the pairs of side walls 24b define spaces S3. The spaces S3 are closed by the side flanges 14 of the lower bracket 10 (described in detail below).

As described above, in the present embodiment, the projections 24 include the inclined walls 24a and the pairs of side walls 24b. However, the configuration of the projections 24 is not limited thereto. In another embodiment, for example, each projection 24 may include one or more curved surfaces as long as the projection 24 includes the first contour P1 and the second contour P2 when viewed in the front-rear direction of the vehicle 500.

The space S2 is defined between the pair of projections 24. The top of the space S2 is closed by the console box 50. As described above, for example, the space S2 may accommodate components such as ducts or wiring.

Referring to FIG. 6, the upper bracket 20 further includes side flanges 25 for each of the projections 24. The side flanges 25 extend in the top-bottom direction and the front-rear direction of the vehicle 500. The side flanges 25 do not have to be completely parallel to the top-bottom direction and the front-rear direction, and may be inclined with respect to one or more of the top-bottom direction and the front-rear direction. The side flanges 25 are coupled to the projections 24. The side flanges 25 extend outwardly from the edges of the projections 24.

Referring to FIG. 2, the side flanges 25 contact the side flanges 14 of the lower bracket 10. At least a part of the side flanges 25 is fixed to the side flanges 14 by a fixing method such as spot welding or an adhesive. Thus, as described above, the spaces S3 are closed by the side flanges 14 of the lower bracket 10. That is, the inclined walls 24a and the pairs of side walls 24b of the projections 24 and the side flanges 14 of the lower bracket 10 form the closed spaces S3.

The upper bracket 20 as described above may be formed by, for example, pressing a metal plate.

Next, the function of the center console 100 at the time of a side impact of the vehicle 500 will be described.

Referring to FIG. 1, when the vehicle 500 is struck from the side, a load (side load) F may be applied to a seat frame 202. When the load F increases, the seat frame 202 may be displaced to come into contact with the bracket 1 of the center console 100. In this case, the load F is transmitted from the seat frame 202 to the bracket 1.

As described above, in the center console 100 according to the present embodiment, the projections 24 are configured to face the seat frames 202 in the vehicle width direction. The load F is therefore transmitted from the seat frame 202 to the side flange 14 (not illustrated in FIG. 1), which closes the projection 24, and to the projection 24.

Referring to FIG. 3, when the load F is applied to the side flange 14 and the projection 24, a bending moment about the lower end of the side flange 14 and the projection 24 is generated in the side flange 14 and the projection 24. The bending moment is applied to the side flange 14 and the projection 24 so as to bend the side flange 14 and the projection 24 about the lower ends.

However, in the present embodiment, the projections 24 include the second contours P2 that extend downward and inward in the vehicle width direction of the vehicle 500 from the upper ends of the first contours P1. The second contours P2 support the projections 24 and the side flanges 14 against the bending moment. Therefore, the second contours P2 can reduce the possibility that the projections 24 and the side flanges 14 are bent by the bending moment.

Furthermore, in the present embodiment, the lower bracket 10 is inserted between the upper bracket 20 and the floor tunnel T. The upper wall 11 of the lower bracket 10 supports the lower ends of the second contours P2. The upper wall 11 is coupled to the support walls 12 fixed to the floor tunnel T. Therefore, the load applied to the second contours P2 is supported by the upper wall 11 and the support walls 12 of the lower bracket 10, in addition to the side walls 22 of the upper bracket 20. Therefore, the load F resulting from the side impact can be dispersed across the lower bracket 10 and the upper bracket 20.

As described above, the center console 100 according to the present embodiment includes the console box 50 disposed between the pair of seats 200 arranged in the vehicle width direction, and the bracket 1 via which the console box 50 is fixed to the floor 300 of the vehicle 500. The bracket 1 includes the lower bracket 10 and the upper bracket 20 disposed on the lower bracket 10. The upper bracket 20 includes a pair of projections 24 facing the seat frames 202 of the pair of seats 200 in the vehicle width direction. When viewed in the front-rear direction of the vehicle 500, each of the pair of projections 24 includes the first contour P1 extending vertically and the second contour P2 extending downward and inward in the vehicle width direction from the upper end of the first contour P1. The lower bracket 10 includes the upper wall 11 that supports the lower ends of the second contours P2 of the pair of projections 24, and the support walls 12 disposed between the upper wall 11 and the floor 300. With this configuration, during a side impact of the vehicle 500, the projections 24 can receive the side load F from the seat frame 202. In addition, the second contours P2 of the projections 24 support the projections 24 against the bending moment caused by the load F. Therefore, the second contours P2 can reduce the possibility that the projections 24 are bent by the bending moment. Therefore, it is possible to improve the strength against the side load F. Furthermore, according to such a configuration, the space S2 can be formed between the second contours P2 of the pair of projections 24. Thus, the space S2 for accommodating components such as ducts or wiring can be ensured.

Furthermore, in the center console 100, the support walls 12 of the lower bracket 10 include the first support wall 12 and the second support wall 12 facing each other in the front-rear direction, and the upper wall 11 is coupled to the upper ends of the first support wall 12 and the second support wall 12. With this configuration, the load transmitted from the second contours P2 to the upper wall 11 can be supported by the two support walls 12. Therefore, the strength against the side load F can be further improved.

In the center console 100, the lower bracket 10 includes the pair of side flanges 14 that cover the first contours P1 of the projections 24 from the outer side in the vehicle width direction. The projections 24 and the side flanges 14 are fixed to each other to form the closed spaces S3. With this configuration, the projections 24 can be formed as hollow members, and the weight of the bracket 1 can be reduced. Furthermore, because the projections 24 and the side flanges 14 are fixed to each other, it is possible to reduce the possibility that the projections 24 are deformed by the bending moment. Therefore, the strength against the side load F can be further improved.

Although the preferred embodiment of the disclosure has been described above with reference to the accompanying drawings, the disclosure is of course not limited to such embodiment. It will be apparent to those skilled in the art that various modifications and variations can be made without departing from the spirit or scope of the disclosure as defined in the appended claims.

For example, in the above embodiment, the lower bracket 10 includes the pair of support walls 12, and the upper wall 11 and the pair of support walls 12 generally form an inverted U-shaped cross section when viewed in the left-right direction. However, the cross-sectional shape of the lower bracket 10 is not limited thereto. For example, in another embodiment, the lower bracket 10 may include only one support wall 12, and the upper wall 11 and the support wall 12 may form a T-shaped cross section when viewed in the left-right direction. Furthermore, in another embodiment, the lower bracket 10 may include two support walls 12 intersecting each other, and the two support walls 12 may form an X-shaped cross section when viewed in the left-right direction.

Furthermore, for example, in the above-described embodiment, the console box 50 is fixed to the side flanges 14 of the lower bracket 10. However, the method of fixing the console box 50 via the bracket 1 is not limited thereto. For example, in another embodiment, the side flanges 25 of the upper bracket 20 may be extended upward, and through holes for bolts may be provided in the side flanges 25. The console box 50 may be fixed to one or more of the side flanges 14 of the lower bracket 10 and the side flanges 25 of the upper bracket 20.

Furthermore, for example, in the above-described embodiment, the upper wall 21 is formed between the pair of projections 24. However, the configuration of the upper bracket 20 is not limited thereto. For example, in another embodiment, the upper bracket 20 does not have to include the upper wall 21, and the lower ends of the second contours P2 of the pair of projections 24 may be coupled to each other.

According to the disclosure, the strength against a side load can be improved.

1. A center console comprising:
a console box disposed between a pair of seats arranged in a vehicle width direction; and
a bracket configured to fix the console box to a floor of a vehicle,
the bracket comprising:
a lower bracket; and
an upper bracket disposed on the lower bracket,
the upper bracket comprising a pair of projections facing seat frames of the seats respectively in the vehicle width direction,
each of the projections comprising:
a first contour extending vertically when viewed in a front-rear direction of the vehicle; and
a second contour extending downward and inward in the vehicle width direction from an upper end of the first contour when viewed in the front-rear direction,
the lower bracket comprising:
an upper wall configured to support a lower end of the second contour of each of the projections; and
a support wall disposed between the upper wall and the floor.

2. The center console according to claim 1, wherein
the support wall includes a first support wall and a second support wall facing each other in the front-rear direction, and
the upper wall is coupled to an upper end of the first support wall and an upper end of the second support wall.

3. The center console according to claim 1, wherein
the lower bracket includes a pair of side flanges that each cover the first contour of a corresponding one of the projections from an outer side in the vehicle width direction, and
the projections and the side flanges are fixed to each other to form closed spaces.
